(19) United States
(12) Patent Application Publication
(10) Pub. No.: US 2013/0247578 A1
(43) Pub. Date: Sep. 26, 2013

(54) METHOD FOR OPERATING A FIXED GAS TURBINE, DEVICE FOR REGULATING THE OPERATION OF A GAS TURBINE AND POWER PLANT

(71) Applicants: Eberhard Deuker, Mulheim an der Ruhr (DE); Jan Eickelkamp, Oberhausen (DE); Boris Ferdinand Kock, Ratingen (DE); Berthold Köstlin, Duisburg (DE); Jürgen Meisl, Mulheim an der Ruhr (DE); Dennis Nehlsen, Voerde (DE)

(72) Inventors: Eberhard Deuker, Mulheim an der Ruhr (DE); Jan Eickelkamp, Oberhausen (DE); Boris Ferdinand Kock, Ratingen (DE); Berthold Köstlin, Duisburg (DE); Jürgen Meisl, Mulheim an der Ruhr (DE); Dennis Nehlsen, Voerde (DE)

(21) Appl. No.: 13/990,098

(22) PCT Filed: Nov. 29, 2011
(86) PCT No.: PCT/EP2011/071243

§ 371 Date: May 29, 2013

(30) Foreign Application Priority Data
Nov. 30, 2010 (EP) 10193135.0

(51) Int. Cl. F02C 7/22

(52) U.S. Cl. CPC F02C 7/22
USPC 60/776; 60/39.461

(57) ABSTRACT

A method of operating a gas turbine, a device for regulating the starting and/or the operation of a gas turbine and a power plant are provided. The method includes continuously extracting fuel from a fuel network, and combusting, in at least one combustion chamber of a gas turbine, the fuel by adding combustion air. For an increase of a fuel stream supplied to the at least one combustion chamber, a fuel volume is extracted from a fuel store and supplied to the fuel still to be supplied to the at least one combustion chamber.

### CROSS REFERENCE TO RELATED APPLICATIONS

This application is the US National Stage of International Application No. PCT/EP2011/071243 filed Nov. 29, 2011, and claims benefit thereof, the entire content of which is hereby incorporated by reference. The International Application claims priority to European Application No. 10193135.0 EP filed Nov. 30, 2010, the entire contents of which is hereby incorporated by reference.

### FIELD OF INVENTION

The invention relates to a method for operating a static or stationary gas turbine, having the steps:

continuous extraction of gaseous fuel from a fuel network and

combustion of the fuel, with the addition of combustion air, in at least one combustion chamber of the gas turbine.

The invention also relates to a device for regulating the operation of a gas turbine. Finally, the invention relates to a power plant comprising a gas turbine having at least one combustion chamber and one compressor, wherein to the combustion chamber there can be supplied combustion air provided by the compressor and fuel that can be extracted continuously from a fuel network.

### BACKGROUND OF INVENTION

A wide variety of static gas turbines and methods for operating the gas turbines are known from the available prior art. Gas turbines of modern construction which are used for generating electrical energy generally have an axial-throughflow compressor, one or more combustion chambers, and a turbine unit. During operation, a fuel supplied to the combustion chamber is burned, with the aid of the ambient air compressed by the compressor, to form a hot gas which expands in the turbine unit at the rotor of the gas turbine while performing work. The rotor then drives a generator which converts the mechanical energy into electrical energy with low losses, and feeds said electrical energy into an electricity distribution grid.

Upon the starting of the gas turbine, the rotor thereof is accelerated to an ignition rotational speed with the aid of a drive device, whereafter, by the infeed of a pilot fuel flow into the combustion chamber, said combustion chamber is ignited. Subsequently, the pilot flame ignites a main fuel flow which is also injected into the combustion chamber via separate burners and/or fuel nozzles. At the same time, the drive device is decoupled from the rotor. The rotor is then driven only by the hot gas generated during the combustion. The starting process of the gas turbine ends when the operating rotational speed, usually 3000 rpm or 3600 rpm, is reached. The generator can subsequently be synchronized with the grid frequency of the electricity distribution grid and connected thereto.

The supply of the pilot fuel and main fuel to the corresponding burners or nozzles takes place via separately operating line systems with valves arranged therein, by means of which valves the volume of the respectively supplied fuel and the pressure thereof can be adjusted.

Here, as fuel, use is made of both liquid and also gaseous fuels. To generate a particularly efficient and low-emission combustion in the combustion chamber, it is known for the combustion of the main fuel mass stream to be assisted continuously by the pilot flame. As a pilot fuel, use is often made of a combustion gas, for example natural gas.

Owing to the large quantities of fuel required for the generation of large amounts of electrical energy, the fuel line systems of the gas turbine are often connected to a fuel network from which the fuel can be extracted in the required quantities permanently over a relatively long period of time. If appropriate, an additional gas compressor is connected between the fuel network and the fuel line system in order to reliably increase the supply pressure of the fuel network to a higher level at which reliable operation of the gas turbine can be ensured. Here, the required fuel pressure at the infeed into the combustion chamber is higher than the pressure ratio effected by the compressor of the gas turbine. Consequently, the pressure gradient is set such that the fuel also actually flows into the combustion chamber. The supply pressure to be provided by the fuel network or to be delivered by the additional gas compressor may even be considerably higher than the pressure ratio effected by the compressor, because in particular during the acceleration of the rotor to the operating rotational speed and in the event of load shedding, very large quantities of pilot fuel are required in order to stabilize the main flame and reliably prevent undesired thermo-acoustic vibrations and flame quenching. Pilot burners which generate a premixed flame—so-called premix pilot burners—furthermore have relatively small gas outlet bores, which necessitate a further increase of the already high gas supply pressure in order to attain the required pilot gas mass streams. This contradicts the requirement for efficient operability even with a reduced supply pressure in the fuel network.

### SUMMARY OF INVENTION

It is an object to provide a method for operating a gas turbine, a device for regulating the operation of a gas turbine, and a power plant, which method and which device ensure reliable operation even in the case of a minimum supply pressure in the fuel network which lies only slightly above the maximum pressure ratio that can be effected by the compressor of the gas turbine.

The objects directed to the method for operating a gas turbine, to the device, and to a power plant are achieved by a method, a device and a power plant according to the independent claims.

All of the solutions have in common the fact that the invention proposed here is based on the concept of the increased fuel pressure, or increased fuel mass stream, required only briefly for special operating states such as starting, a fuel change, load shedding (also referred to as load rejection) or the like being provided from a fuel store—for example a collecting tank—and of fuel which is extracted from the fuel network being supplied thereto in a pressure-increasing manner when required. It is preferable in the implementation of the method according to the invention for only identical gaseous fuels to be merged. Initial estimations have shown that even in the case of static or stationary gas turbines that can output power of between one hundred MW and four hundred MW, a tank size of approximately 1 m³-3 m³ would already be adequate to store the required fuel quantities at corresponding pressure. For the build-up of pressure in the fuel store, a simple gas compressor with low delivery rate is adequate, because sufficient time is generally available for the filling of the fuel store. Such a gas compressor is significantly cheaper and more reliable than a fuel compressor which must permanently provide the entire fuel mass stream at the high pressure level during operation.

By contrast to previous approaches known from the prior art, it is possible with the invention for the gas turbine to be safely and reliably operated even with a relatively low supply pressure in the fuel network. Even during the special operating states “starting”, “fuel change” and “load shedding (load rejection)”, the fuel mass stream additionally required then, in particular for the one or more pilot burners, is extracted from the fuel store which was previously filled with the fuel volume by means of a simple gas compressor. Here, the fuel volume was self-evidently extracted previously from the fuel network.

The proposed measures considerably reduce the demands on the supply pressure in the fuel network. As a result of the omission of the fuel compressor for relatively high fuel pressures at high fuel mass flow rates, high costs firstly for the procurement of such a high-powered fuel compressor and also for the operation thereof during the operation of the gas turbine can be eliminated.

Embodiments are specified in the dependent claims.

According to a first advantageous method feature, the fuel volume in the fuel store is at a higher pressure than the supply pressure in the fuel network. It is preferable for the pressure in the fuel volume to be higher than the supply pressure in the fuel network by a factor of two to four. It is thus ensured that, when required, the fuel volume can be supplied without delay and in adequate quantities to the combustion in the combustion chamber. To achieve this, it is possible by means of a fuel compressor for fuel to be extracted from the fuel network and stored in the fuel store during the operation of the gas turbine and/or during the standstill phase. Since there is thus an adequately long time period available for the charging of the fuel store, it is possible to use a fuel compressor of relatively low power.

Furthermore, the method provides that, for the brief increase of the pilot fuel supplied to the combustion chamber via a pilot burner or via a plurality of pilot burners of the gas turbine, the fuel volume extracted from the fuel store is supplied to the pilot fuel still to be supplied to the combustion chamber. Undesired and unstable combustion states can be avoided in particular in this way.

If, instead of the fuel that can be extracted from the fuel network, another type of fuel is provided as a fuel volume in the fuel store, it is thus possible for the fuel store to be provided preferably in the form of one or more gas bottles. This eliminates the need to use a fuel compressor. Furthermore, with the different fuel type, if it is more reactive than the fuel to be supplied, the burn-out of the fuel to be supplied can be further improved. This increases the efficiency of the combustion, whereby the generally required thermal input—that is to say thermal power—is reduced. Since natural gas or synthesis gas is usually used as gaseous fuel, more reactive fuels are for example hydrogen or acetylene.

The reactivity may be described by a shorter ignition delay time. With an increasing fraction of the more reactive fuel volume in the fuel, the flame speed increases and the ignition delay time decreases. Both characteristic variables are therefore indicators that, through the admixing of hydrogen or acetylene, a considerably faster and more compact combustion can be realized, which, for a given residence time of the hot gas in the combustion chamber, yields an improvement in burn-out. It has been found here that a volume fraction of 10% to 30% of more reactive fuel in the overall fuel stream supplied is already adequate to increase the thermal efficiency and to give lower overall emissions of unburned fuel, in particular unburned hydrocarbons and carbon monoxide. The latter applies in particular to the pilot combustion if the main combustion—for example in the event of load shedding (load rejection)—is virtually or even completely stopped. At the same time, the improvement of the thermal burn-out for a given mass stream of the (pilot) fuel stream permits more stable overall thermo-acoustic behavior of the combustion.

The rotor of the gas turbine, in the case of gas turbines used for energy generation, is preferably coupled during operation to an electrical generator, wherein the generator in turn is connected to an electricity distribution grid. Within the context of this application, load shedding (load rejection) is to be understood to mean that either an abrupt reduction in the electrical power to be imparted by the generator occurs, or the generator is even separated from the electricity distribution grid, that is to say the electrical power to be imparted by the generator is reduced abruptly to 0. Such load shedding (load rejection) is conventionally unplanned and thus occurs only in the event of a fault. It is also possible for such load shedding to be simulated during the commissioning of static or stationary gas turbines in order to be able to guarantee the reliable and safe operation of the gas turbine before it is first put into commercial operation.

According to the invention, to carry out the above-described method and the preferred embodiments thereof, there is provided a device for regulating the operation of a gas turbine, said device comprising:

an input to which can be supplied a signal which, in a special operating state, represents the demand for additional fuel and/or the lack of gas supply pressure,

an output whose signal controls an actuating element by means of which a fuel volume that can be extracted from a fuel store can be supplied to a fuel, and

a unit which controls the output signal as a function of the input signal. According to the invention, the power plant comprises at least one gas turbine and a fuel store that can be filled with a fuel volume, and also means by which the fuel volume can be supplied to the fuel that can be extracted continuously from the fuel network.

The above-stated means preferably comprise a line which connects the fuel store to a line portion, in which line there is arranged an actuating element for opening and closing the line. To prevent pressure shocks in the merged fuel stream, it is possible for at least one jet pump to be provided in the fuel line system, to which jet pump can be supplied, as medium to be pumped, the fuel that can be extracted continuously from the fuel network and to which jet pump can be supplied, as pump fluid, the fuel volume that can be extracted from the fuel store, wherein the respective jet pump is connected at the outlet side to at least one burner of the gas turbine.

### BRIEF DESCRIPTION OF THE DRAWINGS

The invention will be explained further on the basis of the exemplary embodiments illustrated in the drawing, in which, in detail:

FIG. 1 shows a first exemplary embodiment of a fuel supply system of a power plant,

FIG. 2 shows an alternative embodiment of the fuel supply system of a power plant having a jet pump, and

FIG. 3 shows a further alternative embodiment of the fuel supply system of a power plant having a fuel store, formed from gas bottles, for a more reactive fuel volume.

### DETAILED DESCRIPTION OF INVENTION

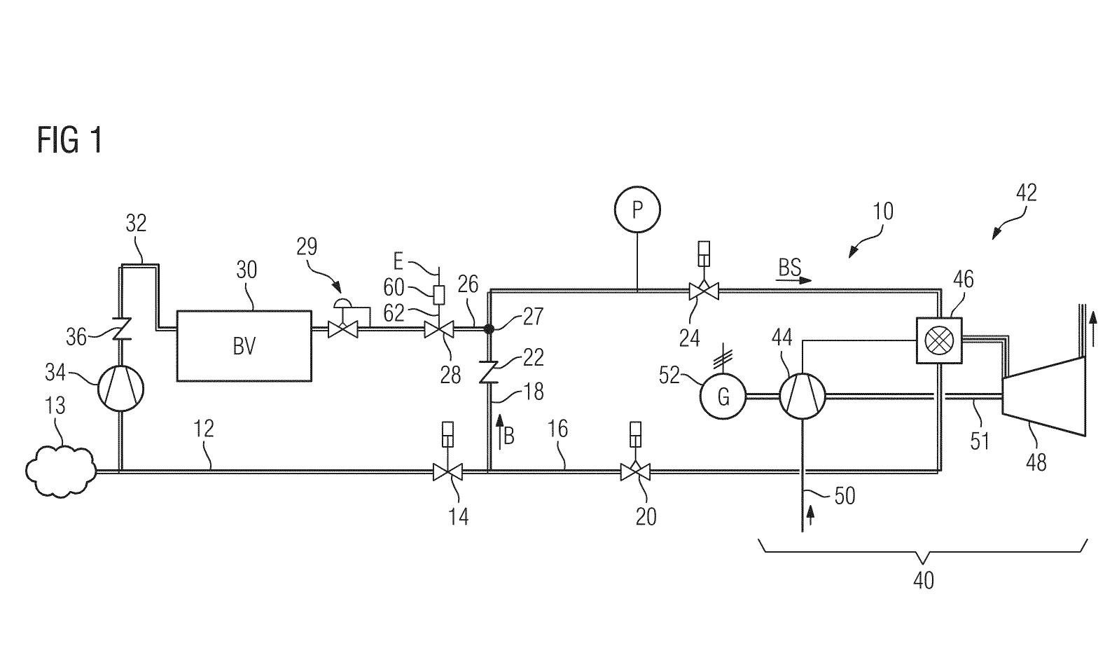

FIG. 1 shows a power plant 42 having a gas turbine 40. Said gas turbine comprises a compressor 44 of axial type of construction, one or more combustion chambers 46, and a turbine unit 48 which is likewise of axial type of construction. During the operation of the gas turbine 40, ambient air is sucked in by the compressor 44 via an intake line 50 and fed as compressed compressor outlet air into the combustion chamber 46. Both a pilot fuel stream and also a main fuel stream are supplied via one or more burners or stages to the combustion chamber 46 or the combustion chambers 46 and burned, in conjunction with the compressed ambient air, to form a hot gas which expands in the turbine unit 48 at a rotor 51 of the gas turbine 40 while performing work. Said rotor drives a generator 52, which is coupled thereto, for generating electrical energy.

The gas turbine 40 of the power plant 42 is connected via a fuel supply system 10 to a fuel network 13. The fuel network 13 is capable of delivering the required quantity of gaseous fuel in order to permanently operate the gas turbine 40 at rated load. In detail, aside from further components which are not illustrated, the fuel supply system 10 comprises a first fuel line 12, the inlet of which is connected to the fuel network 13. A first valve 14 as a safety shut-off device is arranged in the first fuel line 12. Downstream of the first valve 14, the first fuel line 12 divides into two line portions 16, 18. The first line portion 16 is part of a main fuel supply system and leads to a second valve 20, by means of which the volume of the main fuel mass stream to the gas turbine 40 can be adjusted. The second line portion 18 is part of a pilot fuel supply system and leads via a first check valve 22 to a third valve 24 by means of which the volume of the pilot fuel mass stream, which can be conducted to the pilot burner or the pilot burners of the gas turbine 40, can be adjusted.

At an infeed point 27 downstream of the check valve 22, a further fuel line 26 issues into the line portion 18. A shut-off valve 28 and a pressure reducing unit 29 are provided in said further fuel line 26. The inflow-side end of the fuel line 26 is connected to a fuel store 30 which, as a fuel tank, is provided with a volume of for example 2m³. Fuel can be supplied from the fuel network 13 to the fuel store 30 via a supply line 32 in which a gas compressor 34 and a check valve 36 are connected in series, which fuel can then be used in special operating states as a fuel volume BV. The use of the pressure reducing unit 29 facilitates the compensation of pressure fluctuations upon the opening of the shut-off valve 28.

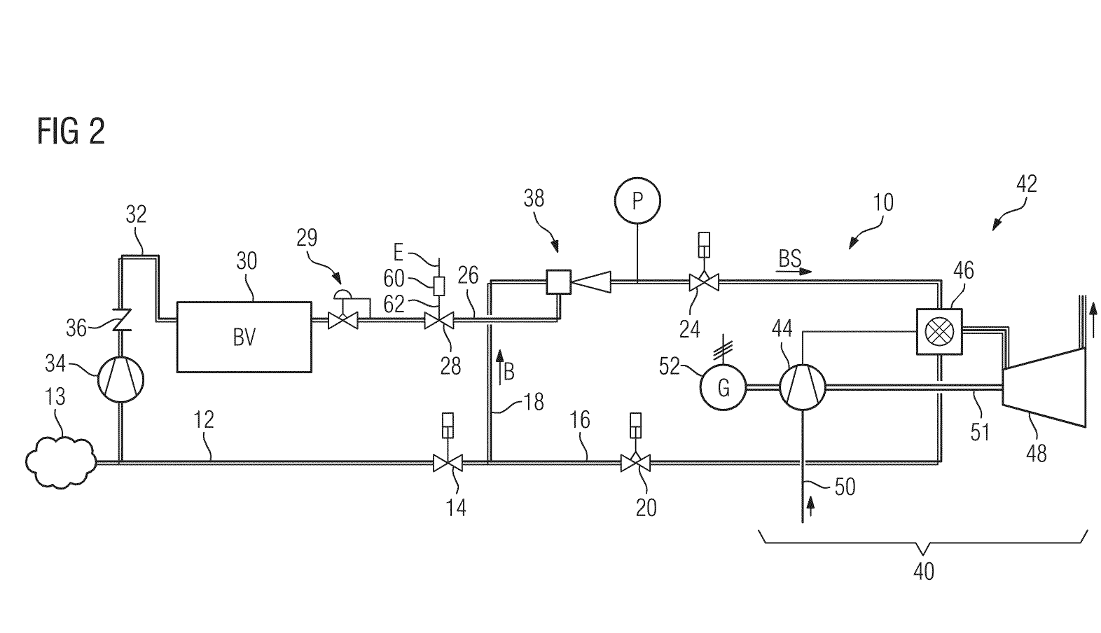

In an alternative embodiment of the fuel supply system 10 illustrated in FIG. 2, said fuel supply system has a jet pump 38 instead of the infeed point 27, wherein the fuel volume BV that can be stored in the fuel store 30 can be supplied as pump fluid to said jet pump 38 via the line 26 and the valve 28 arranged therein in order to increase the overall pressure of the fuel B at relatively low pressure flowing in the line portion 18.

As regards the stabilization of the combustion that takes place in the combustion chamber 46 of the gas turbine 40 during the starting of the gas turbine 40, during a fuel change and/or during load shedding (also called load rejection), the two embodiments illustrated in FIG. 1 and FIG. 2 operate in a similar manner, as will be described below.

Before the starting of the gas turbine 40 or also after the extraction of a fuel volume BV from the fuel store 30, the gas compressor 34 is operated in order to (re)fill the fuel store 30 with a fuel volume BV. The fuel volume BV stored in the fuel store 30 is then at a predefined, relatively high pressure which is several times—for example three times—higher than the supply pressure in the fuel network 13 or than the maximum pressure ratio that can be effected by the compressor 44.

During the starting of the gas turbine 40, the rotor 51 is accelerated to an ignition rotational speed by means of a rotational device (not illustrated) or by means of the generator 52. Subsequently, at least the valves 14, 24 are opened and the pilot flame is ignited, such that a combustion takes place in the combustion chamber 46. Subsequently, the second valve 20 is opened such that the main combustion begins. Subsequently, the rotor 51 is accelerated to the operating rotational speed through the continuous increase of the fuel mass stream. Combustion instabilities arising during this time can then be reliably avoided if, upon or directly after the attainment of the respective rotational speeds, an additional fuel volume BV extracted from the fuel store 30 is supplied, with the fuel B extracted from the fuel network 13 and flowing in the second line portion 18, to the combustion chamber 46 for example via the pilot burners. In this case, a particularly large quantity of fuel B can be fed at particularly high pressure into the combustion chamber 46 until the respective rotational speeds have been exceeded. Owing to the thus increased pilot fuel quantity, the flame generated by the pilot burner is stabilized. At the same time, undesired thermo-acoustic vibrations and flame quenching are reliably prevented.

To prevent an abrupt increase of the pressure in the second line portion 18 upstream of the valve 24, the valve 28 must be opened correspondingly slowly. The fuel stream BS through the valve 24 is also fed out of the fuel store 30 until the pressure thereof has fallen to the normal supply pressure which prevails in the second line portion 18.

In the event of load shedding (load rejection), it is generally the case that most or all of the fuel valves of the main burners are immediately or substantially closed in order to as effectively as possible prevent the acceleration of the rotor 51 to an excessive rotational speed, whereas the fuel valves of the pilot burners remain open for continued operation of the gas turbine 40. If load shedding (load rejection) must be performed, whether unplanned or planned during the commissioning of the gas turbine 40, it is possible for the pilot flame(s) in the one or more combustion chamber(s) 46 to be stabilized in that, upon or directly after the load shedding, the gaseous fuel volume BV is extracted from the fuel store 30 by opening the valve 28 and is to be supplied to the fuel B extracted from the fuel network 13 and flowing in the second line portion 18, whereby the merged fuel stream BS downstream of the infeed point 27 is increased in pressure P. The pressure increase leads to a greater fuel quantity flowing into the combustion chamber 46, which has a stabilizing effect.

The above-described method may also be implemented if a fuel change is provided during the operation of the gas turbine 40. During the fuel change, a switch is made from a liquid main fuel to a gaseous main fuel—or vice versa. For said switchover process, which lasts approximately 30 seconds to approximately 180 seconds, a stabilizing combustion of the pilot flame is necessary, which is achieved only by means of the fuel volume BV injected additionally during said period. In this respect, the flame stabilization operation, by means of the pressure increase resulting from the addition of the fuel volume BV to the fuel, takes place only for a short time period. After the fuel change, operation can be continued as normal—that is to say without addition of the fuel volume BV.

In the embodiment according to FIG. 2, the fuel volume BV stored in the fuel store 30 operates as pump fluid for the fuel B which flows in the second line portion 18 and which was originally extracted from the fuel network 13. The merging of the fuel B and of the fuel volume BV to form the fuel stream BS takes place in the jet pump 38, such that the interaction of the two fuel streams B, BV acts to provide the necessary pressure increase in the line portion 18 downstream of the jet pump 38. As a result of the use of the jet pump 38, the fuel store 30 can be designed to be smaller. In this way, too, a significantly smoother pressure increase upstream of the valve 24 during the opening of the valve 28 is possible. In this way, the valve 28 may possibly be designed to be very much simpler and thus less expensive. If appropriate, the valve 28 may thereby also be designed as a switching valve—a regulating valve is then not required.

The control of the valve 28 is performed by means of a device 60. The device 60 has firstly an input E to which can be supplied a signal which represents the demand for additional fuel or the lack of gas supply pressure. Said signal is preferably the present rotational speed of the gas turbine rotor 51, a signal representing the load state of the gas turbine 40, or signal representing the fuel change. Furthermore, the device 60 comprises an output 62 whose signal controls an actuating element, preferably the valve 28, by means of which the fuel volume BV that can be extracted from the fuel store 30 can be supplied to the fuel B flowing in the second line portion 18. Furthermore, the device 60 comprises a unit which controls the output signal as a function of the input signal in accordance with the specified method.

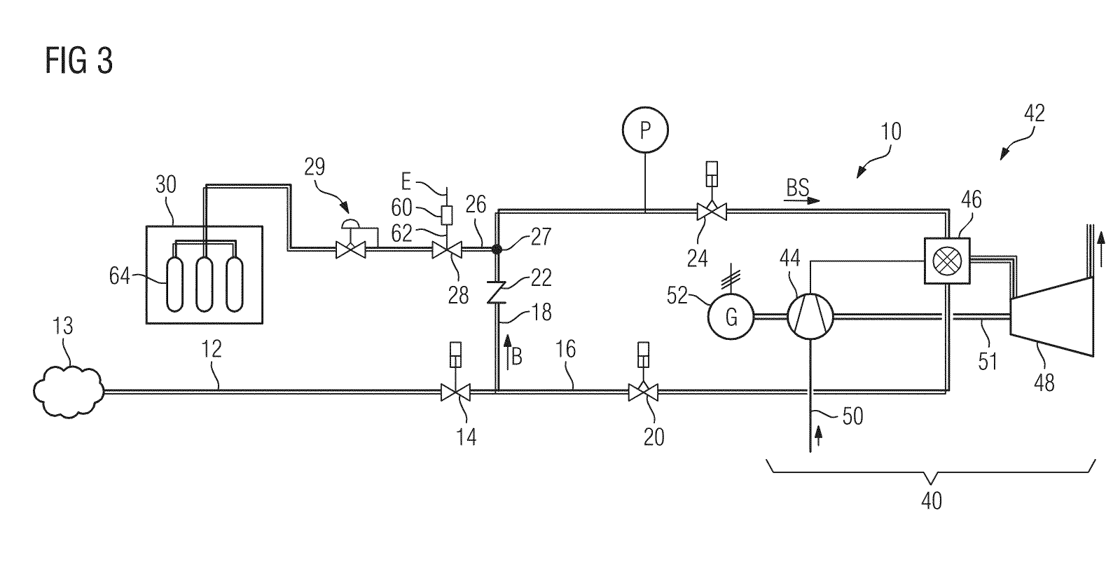

In the exemplary embodiment according to FIG. 3—and by contrast to the exemplary embodiment according to FIG. 1—the fuel store 30 is in the form of a gas bottle or in the form of a battery of a plurality of gas bottles 64 connected in parallel. In said gas bottles 64 there is stored, for use as a fuel volume BV, a fuel significantly more reactive than the fuel B that can be extracted from the fuel network 13. Hydrogen or acetylene, for example, is stored in the gas bottles 64. Said fuel can, as the fuel volume BV in the above-described applications, be briefly added to the fuel B extracted from the fuel network 13 in order to improve the burn-out and in order to provide thermo-acoustic stabilization of the combustion.

The exemplary embodiments illustrated in FIG. 1, FIG. 2 and FIG. 3 serve merely for explanation of the invention and do not restrict the invention, and may also be combined with one another.

It is thus possible in particular for a plurality of combustion chambers 46 to be provided which comprise in each case one pilot burner and one main burner with in each case one or more stages, wherein said pilot burners are connected to the fuel supply system 10. It is self-evidently also possible for the main burners to additionally be supplied with the fuel volume BV extracted from the fuel store 30 in order, in an analogous manner, to stabilize the main flame(s) during similar operating states. The invention has been described on the basis of an example with gaseous fuel. The use of gaseous fuel is however not imperative. It is self-evidently also possible for liquid fuels to be conveyed in the fuel supply system 10 according to the invention. A combination of liquid and gaseous fuels is also possible, wherein however mixing of liquid and gaseous fuels at the infeed point 27 or in the jet pump 38 is not provided, but rather a separation of gaseous fuel and liquid fuel is provided with regard to pilot fuel and main fuel: it may thus be provided that the pilot fuel is gaseous and the main fuel is liquid, or vice versa.

The power plant 42 may also comprise a steam turbine unit (not illustrated in any more detail) whose rotor is likewise coupled to the illustrated generator 52 on a common shaft, said shaft then also being referred to as a shaft train.

Overall, therefore, the invention specifies a method for starting a gas turbine 40, a method for operating a gas turbine 40 in the event of load shedding (load rejection) or a fuel change, a device 60 for regulating the operation of a gas turbine 40, and a power plant 42.

To permit reliable operation of the gas turbine 40 during starting, in the event of load shedding (load rejection) or in the event of a fuel change despite an only relatively low supply pressure of the fuel network 13, it is provided that a fuel volume BV with a pressure increased significantly in comparison to the supply pressure in the fuel network 13 is provided and is supplied briefly to the fuel B extracted from the fuel network 13, in order to increase the pressure thereof, when required. Through the provision of a relatively high fuel pressure, the pilot flame can burn in a stabilized manner in the required operating situations. Thermo-acoustic vibrations and flame quenching can also be prevented even though the supply pressure permanently provided by the fuel network 13 is relatively low.

1-17. (canceled)

18. A method for operating a stationary gas turbine, comprising:
continuously extracting fuel from a fuel supply network, and
combusting, in at least one combustion chamber of a gas turbine, the fuel by adding combustion air,
wherein, for an increase of a fuel stream supplied to the at least one combustion chamber, a fuel volume is extracted from a fuel store and supplied to the fuel still to be supplied to the at least one combustion chamber.

19. The method as claimed in claim 18, wherein the increase of the fuel stream is performed during starting of the gas turbine and/or in an event of a fuel change and/or upon or directly after load rejection.

20. The method as claimed in claim 18, wherein the fuel volume is at a higher pressure than the fuel extracted from the fuel supply network.

21. The method as claimed in claim 20, wherein the pressure of the fuel volume is two to four times higher than a supply pressure in the fuel supply network.

22. The method as claimed in claim 18, wherein, for the increase of the fuel supplied to the at least one combustion chamber via a pilot burner or via a plurality of pilot burners of the gas turbine, the fuel volume extracted from the fuel store is supplied to the fuel still to be supplied to the at least one combustion chamber.

23. The method as claimed in claim 19, wherein the gas turbine drives an electrical generator which is connected to an electricity distribution grid, and wherein the load rejection takes place as a result of an abrupt reduction in electrical power to be imparted by the generator or as a result of separation of the generator from the electricity distribution grid.

24. The method as claimed in claim 19, wherein the load rejection is unplanned or simulated.

25. The method as claimed in claim 18, wherein a fuel volume with a higher pressure extracted from the fuel supply network is supplied to the fuel store.

26. The method as claimed in claim 18, wherein the fuel store comprises a fuel volume which differs from the fuel and which is provided in gas bottles.

27. The method as claimed in claim 26, wherein the fuel volume is of a significantly more reactive type than the fuel still to be supplied.

28. The method as claimed in claim 26, wherein the fuel volume comprises acetylene and/or hydrogen.

29. A device for regulating an operation of a stationary gas turbine, comprising:
an input, wherein an input signal which represents a demand for additional fuel or the lack of gas supply pressure is supplied to the input,
an output, wherein an output signal controls an actuating element for supplying a fuel volume extractable from a fuel store to a fuel, and
a control unit for controlling the output signal as a function of the input signal.

30. The device as claimed in claim 29, wherein the device is configured to control a method as claimed in claim 17.

31. A power plant, comprising:
a stationary gas turbine with at least one combustion chamber and a compressor,
a fuel store,
wherein combustion air provided by the compressor and fuel extracted continuously from a fuel supply network is supplied to the at least one combustion chamber,
wherein the fuel store is filled with a fuel volume, and
wherein the fuel volume is supplied to the fuel extracted continuously from the fuel supply network.

32. The power plant as claimed in claim 31, further comprising:
a line which connects the fuel store to a line portion for supplying the fuel volume to the fuel extracted from the fuel supply network,
wherein the line comprises an actuating element for opening and closing the line.

33. The power plant as claimed in claim 32, further comprising:
at least one jet pump,
wherein the fuel extracted from the fuel network is supplied to the at least one jet pump, and
wherein the fuel volume extracted from the fuel store is supplied to the at least one jet pump as pump fluid,
wherein the at least one jet pump is connected at an outlet side to at least one burner of the gas turbine.

34. The power plant as claimed in claim 31, further comprising:
a device as claimed in claim 29.
